(19) United States
(12) Patent Application Publication
(10) Pub. No.: US 2004/0236654 A1
(43) Pub. Date: Nov. 25, 2004

(54) Investment grade Shari'ah (Islamic)compliant consumer financial product

(76) Inventor: Joanne Marlowe-Noren, Wadsworth, IL (US)

Correspondence Address: Paul E. Schaafsma, Unit 221, 521 West Superior, Chicago, IL, 60610, US

(21) Appl. No.: 10/860,253

(22) Filed: Jun. 3, 2004

Related U.S. Application Data
(63) Continuation-in-part of application No. 10/295,087, filed on Nov. 15, 2002.

(51) Int. Cl. G06F 17/60

(52) U.S. Cl. 705/35

(57) ABSTRACT

A financial instrument in accordance with the principles of the present invention promotes consumer investment using a consistently formatted investment unit, which fosters the development of a secondary market for those investment units thus affording certain investment liquidity to the consumer. Specifically, the present invention creates a standardized platform for the operation of a consumer-oriented Shari'ah compliant security in support of certain depository account functions that are themselves Shari'ah compliant, but more in keeping with conventional economic or banking norms such that passive to semi-passive consumer deposits originating form the Muslim market sector may be cultivated and promoted within banks and like financial institutions. A financial instrument formulated in accordance with the principles of the present invention provides for the creation of a far more manageable and efficient consumer-based Islamic investment account function than present practices permit. Further, a networked application of the present invention can overcome significant logistical considerations to appointing and designating a SSB for on-going matters of Shari'ah compliance and supervision.

### RELATED APPLICATION

This application is a continuation-in-part of U.S. patent application Ser. No. 10/295,087 titled “INVESTMENT GRADE SHARI'AH (ISLAMIC) COMPLIANT FINANCIAL PRODUCT” filed on 15 Nov. 2002.

### FIELD OF THE INVENTION

The present invention relates to investment grade Shari'ah (Islamic) compliant financial products.

### BACKGROUND OF THE INVENTION

Historically, the Islamic versus non-Islamic investment philosophies have operated as wholly independent and virtually unrelated investment and finance systems for hundreds if not thousand of years. In Islamic economies, Shari'ah (Islamic) financial guidelines are applied and practiced which are clearly understood by Islamic institutions and practicing Muslims. Shari'ah investment principles and religious guidelines refer to Islamic law related to financial and investment matters within the Islamic or Muslim community. Examples of such Shari'ah guidelines that effect compliant consumers include the prohibitions against the payment or collection of interest, or riba, (which constitutes the ‘forbidden profit’ which is identified in the Holy Quran) and the deployment of funds to investments that are not acceptable under Shari'ah law. Thus, within Islamic economies, banking and other similar financial institutions have grown in strength by providing consumer or retail depository or investment account structures and products that operate in a Shari'ah compliant manner. These ultimately support Shari'ah compliant projects and investments within the global Islamic community. For example, one such account structure consists of savings accounts which pay a small premium, or hiba, at the discretion of the bank. A further example are investment accounts which require a longer deposit/investment duration and are managed at the complete discretion of the bank or financial institution; just as an equity stake holder, however, these accounts subject the investor to a loss of some or all of its funds. A still further example are special investment accounts which operate similarly to an investment account, but permit the investor to take direction from the bank or financial institution and implement their investment in a specific or recommended project directly. However, many of these products, in order to generate a yield or return to the consumer as depositor in a Shari'ah compliant manner, subject the consumer or depositor to certain risks of loss of all or a portion of the deposit value in the event that the depository institution mismanages or loses money on its wholesale Shari'ah compliant investment portfolio.

To further exasperate Islamic financial consumers, in today's global village, many consumers of the Muslim faith who seek to adhere to Shari'ah (Islamic) financial guidelines reside in geographic areas that do not observe fiscal practices consistent with Shari'ah law. These consumers in most cases do not enjoy basic opportunities for the generation of yield or return on their savings upon the deposit of their funds in conventional financial institutions or banks—that is, banks that do not provide for designated, audited, and segregated Shari'ah compliant depository or investment accounts. Because of these shortcomings of conventional financial and banking institutions, many Islamic consumers refuse to deposit funds into traditional account structures, thereby causing those consumers to have little opportunity for any type of passive yield on their funds. Thus, those in the Muslim communities residing within conventional market geographies are left under-serviced, resulting in little to no financial motivation of those consumers to deposit funds to conventional banking or financial institutions. This practice is, in general, neither consistently good for the economy nor the average consumer's financial interests.

It would thus be desirable to create a standardized financial model within the Islamic marketplace designed to better manage consumer depository and investment risk on a retail level such that bank management error or bank investment portfolio mismanagement do not necessarily expose the consumer to financial loss of its deposits. It is also desirable to create a standardized financial model that will cater to the Islamic consumer on a localized or regional service level such that an Islamic consumer may make passive deposits to a conventional financial institution and benefit from the Shari'ah compliant management of those funds with a reasonable expectation of some yield generation or earnings. It is also desirable to create a standardized financial model that is easily adaptable by banks and financial institutions within the conventional banking marketplace so that Muslim communities residing within conventional market geographies will have access to Shari'ah complaint accounts. This is a significant service and investment opportunity in that these deposited funds may otherwise remain outside the banking system, and have no opportunity for a professionally managed yield generation.

The benefits of the creation of a new model to better manage financial exposure to consumer deposits within existing Shari'ah compliant institutions and conventional, consumer-related institutions with Islamic investment philosophy would be a significant increase in consumer deposits of funds into Islamic as well as conventional institutions. Such an increase will support the growth of available funding for Shari'ah compliant investment opportunities both within and without the Islamic community. This will put the responsibility for deployment of funds into Shari'ah compliant investments to trained investment management professionals which will potentially increase performance of those funds within the community and markets, increase the total amount of funds available for deployment in other related consumer products (such as Shari'ah compliant mortgage products or services), and move grey-market funds—that is, legitimately earned consumer cash which may otherwise remain unreported or outside of the banking systems—into mainstream institutions. It is this dynamic in the Islamic consumer markets and a Shari'ah-compliant extension of the conventional banking and financial markets which has yet to be consistently achieved.

In addition, historically the Islamic consumer has been relegated to a very “hands-on” investment philosophy requiring expertise and opportunity in order to generate enhanced yields. Although some degree of investment passivity has been afforded to the Islamic consumer through Shari'ah compliant consumer investment account structures offered by certain international or Islamic banking or financial institutions, generally only those accounts that do not produce an opportunity for the generation of a yield assure preservation of the deposited amounts. Therefore, in order to achieve stronger market returns and preservation of investment funds, the Islamic investment community has been forced to maintain a very active hand in the structuring of its personal investment portfolios—a practice which is time-consuming, expensive and fraught with commercial risks for the average consumer. Moreover, in many cases, these types of consumer investments lack liquidity, which brings with it a plethora of additional exposure for the consumer in the event that the investment is not performing as was expected.

In the conventional banking and financial markets, strong performing passive investment vehicles can be easily defined and absorbed by the market without need for significant, investment-specific evaluation. For example, the creation of certificates of deposit, interest bearing bonds or notes, municipal and corporate bond products, debentures, and an array of other like consumer investment products have achieved these objectives. The vast majority of these conventional investment vehicles have a readily available resale or secondary market available to them, making concerns for investment liquidity a virtual non-issue. Of note, however, is that many of these widely marketed investment vehicles do not comply with Shari'ah guidelines and are therefore disqualified from purchase by a consumer that subscribes and abides by Islamic law.

In general, two significant issues have hindered the creation of certain Shari'ah compliant vehicles directed at the Islamic consumer within existing Islamic institutions and conventional banking and financial markets. The first issue has been a mutual lack of understanding of the other market's respective practical and philosophical investment requirements. For example, the consumer products availed through the Islamic institutions are modeled on account structures that have existed for a great many years and have proven themselves to be both Shari'ah compliant and economically beneficial. Specifically, the depository institution or bank has historically had little motivation to modify its consumer products since investment losses attributable to deposited funds are shared directly with the consumer as depositor and likewise, yields first cover management fees to the bank with the balance distributed on a pro rata basis with consumer account holders. Such a system is advantageous to the financial institution implementing the investment philosophies on behalf of the Islamic consumer as depositor. Moreover, as long as the conventional markets fail to create alternative investment opportunities that are Shari'ah compliant and which preserve original deposit values, similar to those that already exist in the conventional market, there is a natural market tendency to avoid innovations.

Second, there has also been a lack of innovation and attention to the Islamic consumer financial market by the conventional markets. In failing to recognize, acknowledge and comprehend the key components in achieving and accommodating Shari'ah compliant investments, the conventional investment and business community have not designed effective bridges between proven conventional investment vehicles and consumer-oriented, Shari'ah compliant investment vehicles. Moreover, because much of the collective wealth in the Islamic consumer market is kept in cash rather than deposited to conventional financial institutions, conventional banking and investment markets have failed to recognize the scope and scale of financial growth and benefit available to accommodating Islamic consumers. Although there have been strides in Shari'ah compliant product lines, these strides are highly localized and specialized, contributing to the creation of an Islamic-friendly investment market within the conventional theatre in only small pockets and within niche investment funds, community banks and financial structures. Thus far, there has been no institutionally scaled, universally formatted Shari'ah compliant consumer investment vehicle or product made available for purchase such that the luxury of a certain level of consumer passivity can be fostered and perpetuated within the Islamic investment community.

This type of passive consistent investment vehicle is as critical and elementary to the establishment of the prudent utilization of investment dollars arising from Islamic investors as the conventional consumer bond market or the availability of depository certificates from neighborhood banks are to the day-to-day financial management philosophies of most consumers in the conventional markets. Although a variety of traditional investment grade bond or depository products exist in the conventional consumer markets which include assurances of preservation of original deposit values and fixed income features, no such large-scale, consistent investment grade security exists which caters to the Islamic consumer. Moreover, the creation of such a vehicle would likely perpetuate the development of a secondary market therefore, thus increasing the opportunity for Islamic consumer liquidity while actively invested in such a financial instrument.

Another reason that many banks and financial institutions have been slow to create products addressing this need is one of significant logistical consideration. Effectuating a Shari'ah compliant investment, whether by private placement or otherwise requires oversight or supervision by a Shari'ah Supervisory Board (“SSB”). The SSB is responsible for the on going monitoring of the operations of the project, company or investment as to matters of Shari'ah compliance throughout the life of the investment. A properly structured and recognized SSB consists of three members: minimally two Islamic Scholars (as recognized by the Auditing and Accounting Office of Islamic Financial Institutions (the “AAOIFI”)) and a known and recognized expert in the field or industry of the subject investment, company or project. The SSB not only approves the means by which the investment in implemented, but thereafter actively oversees the operations of the subject investment in order to issue Shari'ah compliance certification (fatwa) throughout the life of the investment. This permits the Islamic consumer to rely upon the propriety of on-going Shari'ah compliance by the bank or financial institution as recipient or their funds. Based on the foregoing, it is reasonable to assume that each and every investment which is to be considered Shari'ah compliant requires the active involvement of at least two Islamic Scholars and potentially the nomination and review by the AAOIFI of a recognized expert to sit on the SSB with the Scholars. Beyond the obvious matter of managing the SSB once put in place for the benefit and certification of a subject investment or consumer program, there is a very real matter of a true shortage of qualified and recognized Islamic Scholars which are available for this type of hands-on oversight and evaluation of candidate investments as a predicate to and as a post-script for every properly effectuated Shari'ah compliant investment. This is a significant factor in efficiently and properly establishing the compliance of a given banking or consumer financial product consistent with (Islamic) financial guidelines.

What is thus needed is a financial instrument that can be applied by banking and financial institutions for the purposes of promoting and facilitating Shari'ah compliant deposits of funds by Islamic consumer or retail customers. Such financial instrument should bridge the religious, cultural and investment criteria “gap” between Islamic and conventional financial practices while providing an effective means to better manage depository and investment risks incurred by consumers in depositing funds to Shari'ah compliant investment accounts. The financial instrument should make compatible what have customarily been viewed as divergent and conflicting investment philosophies (those being, the faith-based, religious considerations of Islamic investors under recognized Shari'ah guidelines, and the traditional financial instruments which form the cornerstone of conventional banking) such that an Islamic consumer is afforded financial services options comparable to those available to consumers in the conventional markets. Such financial instrument should promote the freer flow of Islamic consumer capital into banking and financial institutions to create the type of market dynamic which enables the increase of Shari'ah compliant investment capital to the Islamic community. The financial instrument should give the Islamic consumer the opportunity to earn an attractive yield in a passive investment forum without concern for violating religious principles, allow for the investment within a professional Shari'ah compliant investment management infrastructure to be implemented by the depository institution under an umbrella of institutional accountability, and promote consumer investment using a consistently formatted investment unit which fosters the development of a secondary market for the units thus affording certain investment liquidity to the consumer. Still further, the financial instrument should allow for the active involvement of at least two Islamic Scholars and potentially of a recognized expert without unduly demanding time of these experts.

### SUMMARY OF THE INVENTION

A financial instrument in accordance with the principles of the present invention can be applied in the operation of consumer banking practices for the purposes of promoting and facilitating increased and better administered consumer and retail deposits arising from Islamic consumers and customers in support of the origination of investments in various Shari'ah compliant projects, ventures, financial services areas or operations and/or investment funds. A financial instrument in accordance with the principles of the present invention bridges the religious, cultural and philosophical “gap” inherent in Islamic consumer consideration of conventional financial services offerings or other similar financial services and products. A financial instrument in accordance with the principles of the present invention makes compatible what have customarily been viewed as vastly divergent and conflicting investment philosophies; those being, the faith-based, religious considerations of Islamic consumers, and the traditional, financial models which form the cornerstone of conventional banking services, account structures and consumer-oriented financial instruments. A financial instrument in accordance with the principles of the present invention promotes the freer flow of Islamic consumer capital into banking and financial institutions to create the type of market dynamic which enables the increase of Shari'ah compliant investment capital to the Islamic community via the depository institution. A financial instrument in accordance with the principles of the present invention gives the Islamic consumer the opportunity to earn an attractive yield in a passive investment forum without concern for violating religious principles. A financial instrument in accordance with the principles of the present invention allows for the investment of consumer deposits within a professional Shari'ah compliant investment management infrastructure to be implemented by a depository institution or its nominee under an umbrella of greater institutional accountability for investment outcome.

A financial instrument in accordance with the principles of the present invention promotes consumer investment using a consistently formatted investment unit, which fosters the development of a secondary market for those investment units thus affording certain investment liquidity to the consumer. Specifically, the present invention creates a standardized platform for the operation of a consumer-oriented Shari'ah compliant security in support of certain depository account functions that are themselves Shari'ah compliant, but more in keeping with conventional economic norms such that passive to semi-passive consumer deposits may be cultivated and promoted. A financial instrument formulated in accordance with the principles of the present invention provides for the creation of a far more manageable and efficient consumer-based Islamic investment account function than present practices permit. Further, a networked application of the present invention can overcome significant logistical considerations to appointing and designating a SSB for on-going matters of Shari'ah compliance and supervision.

### BRIEF DESCRIPTION OF THE DRAWINGS

FIG. 1 is a methodological schematic overview of a consumer deposit/subscription through yield payments process in accordance with the principles of the present invention.

FIG. 2 is a methodological schematic showing details of a consumer deposit/subscription process in accordance with the principles of the present invention.

FIG. 3 is a methodological schematic showing payments, cash accounts and investment unit networked repurchase in accordance with the principles of the present invention.

FIG. 4 is a methodological schematic showing repurchase from the consumer via utilization of guarantee in accordance with the principles of the present invention.

FIG. 5 is a methodological schematic showing Shari'ah compliant mechanisms in accordance with the principles of the present invention.

### DETAILED DESCRIPTION OF THE INVENTION

A financial instrument in accordance with the principles of the present invention effectively and diplomatically overcomes significant and well-recognized disadvantages to the Islamic consumer's deposit of funds to Islamic as well as conventional banking and financial institutions. When combined with tried-and-true capital market philosophies and a Shari'ah compliant infrastructure designed to better manage consumer depository risk, a financial instrument in accordance with the principles of the present invention enables the issuance and mass marketing of a Shari'ah (Islamic) compliant passive consumer investment vehicle. This Shari'ah (Islamic) compliant passive vehicle can be acquired openly by Islamic consumers as the basis to inspire Islamic consumer deposits and investments via banking and financial institutions.

A financial instrument in accordance with the principles of the present invention enables the creation of a consumer-related investment vehicle which, as supported by a series of coordinated financial mechanisms, complies with Shari'ah financial guidelines. A financial instrument in accordance with the principles of the present invention enables the creation of an investment vehicle that functions as a means of facilitating or otherwise effectuating a passive or semi-passive investment by a consumer who observes Islamic law in the establishment of its personal funds management strategies and the implementation of its investment practices. While a primary application of the present invention is to an individual who invests in compliance with Shari'ah (Islamic) financial guidelines, the use of the term consumer herein is not meant to limit the application of the present invention.

The structuring of the Shari'ah compliant financial instruments in accordance with the principles of the present invention is designed and fiscally supported in such a way as to qualify as investment-grade, ratable (by Standard & Poor's, 55 Water Street, New York, N.Y. 10041, Moody's Investors Service, Inc., 99 Church Street, New York, N.Y. 10007 or some other comparable credit rating agency) securities comparable with conventional, non-Islamic retail banking and financial market products. Thus, a financial instrument in accordance with the principles of the present invention establishes a standardized foundation upon which Islamic consumers may rely to enable passive, direct and/or indirect investments in depository structures that are conducive to preserving original consumer depository or invested amounts while potentially producing a yield thereon without any concern for violating Shari'ah (Islamic) financial guidelines. Moreover, a financial instrument in accordance with the principles of the present invention provides a basis for consumer investment and fund management flexibility which, to date, has not existed in Shari'ah compliant retail banking or investment opportunities. Specifically, by employing a financial instrument in accordance with the principles of the present invention, the consumer can preserve their original deposited amount, have the potential for the generation of some Shari'ah compliant yield derived from the management of their deposits, remain passive as to the nature of the investment operations or activities, and have the opportunity to “cash-out” of the investment position via the re-sale or remarketing of the financial instrument through a secondary market function.

A financial instrument in accordance with the principles of the present invention encompasses a variety of features that when brought together address and improve upon many of the issues raised in the previous section. Among other things, a financial instrument in accordance with the principles of the present invention combines the definable and consistent nature of a traditional, rated investment-grade depository/cash-based or backed security such as those that conventional institutions have utilized as a consumer/retail banking product or service for decades within an investment structure which hinges upon certain religious edicts of Islam that in themselves are difficult for non-Islamic parties to understand and appreciate. In fact, one of these edicts appears to fly in the face of some of the conventional banking markets most common financial practices: the prohibition of collection or payment of interest (or riba) in exchange for deposited funds or the making of a loan or investment.

A financial instrument in accordance with the principles of the present invention, however, evidence a number of benefits which make the financial products themselves unique in the retail banking and financial markets and serve to highlight the technical complexities of accomplishing the implementation of these features in what is considered a Shari'ah (Islamic) compliant manner by accredited Islamic scholars. In addition to the foregoing, the following identifies the features and key benefits of the financial instrument in accordance with the principles of the present invention:

the financial instruments of the present invention can be applied in the operation of consumer banking practices to promote and facilitate increased and better administered consumer and retail deposits from Islamic consumers and customers in support of the creation of or investment in various Shari'ah compliant projects, ventures, financial services areas or operations and/or investment finds;

the financial instruments of the present invention are uniformly formatted amongst themselves such that a standardized security or financial instrument is created which need not materially vary based upon the underlying use of proceeds derived from the sale or placement of the financial instrument to the Islamic investor;

the financial instruments of the present invention are ratable by a credit rating agency, thus raising placement efficiencies and creating a foundation in the marketplace which is conducive to the valuation and remarketing of the financial instruments (the conditions being right for the evolution of a standardized secondary market for the resale of the financial instruments), thereby assuring some element of interim liquidity of the investment to the Islamic consumer;

by way of certain repurchase covenants, the financial instruments of the present invention have a minimum anticipated value at the conclusion of the depository term which contributes to the ratable nature of the financial instruments and supports the likelihood of a consumer remarketing strategy by creating a “financial floor” to potential losses related to the deposit and any subsequent bank or financial institution implemented investment to which the proceeds of the financial instruments are applied;

by way of the creation of a networked or coordinated application of issuance and remarketing, the financial instruments of the present invention provides for centralization within a single networked Shari'ah Supervisory Board as to matters of initial compliance and, subsequently, functional and operational compliance of the investments or management operations, thereby permitting greater ease and efficiency in managing issues pertaining to Shari'ah compliance;

the financial instrument of the present invention allows for the investment of Islamic consumer deposits within a professional Shari'ah compliant investment management infrastructure to be implemented by a depository institution or its nominee under an umbrella of greater institutional accountability for investment outcome; and

the common thread of a common networked application of the financial technology involving a variety of issuers and guarantors enables the creation of a composite risk management or risk syndication mechanism related to each respective financial instrument issuance, thereby diversifying the investment risk among a variety of banks and financial institutions rather than lumbering that risk exclusively on the Islamic consumer and its respective deposit values.

The foregoing features demonstrate an advantage of a financial instrument in accordance with the principles of the present invention over the retail banking practices previously utilized within the Islamic marketplace. The present invention both better enables and preserves Islamic consumer deposits within an institutionally administered investment environment which has the potential for generating yield on behalf of the consumer/depositor. This mechanism provides the Islamic consumer with many of the same benefits that are consistent with generally accepted consumer depository products presently available in the conventional banking market, but which are not permissible under Shari'ah investment practices. The implementation of the present invention in both Islamic retail banking and financial institutions and within the conventional markets that geographically service Islamic consumers will produce a retail banking climate for the Islamic consumer with more predictable risk management and base-line performance of amounts deposited, greater liquidity to Shari'ah compliant deposits, more accountability for investment performance on behalf of the banking or depository institution, and more continuity and efficiency in Shari'ah compliance considerations between the respective issuers of the financial instruments. In all of the above examples, the common denominator is one of standardization and consistency in a Shari'ah (Islamic) compliant consumer-based retail banking structure which fosters a regularization of the depository risk management features afforded to an Islamic consumer such that investment opportunities and banking practices can reflect some of the better attributes of the conventional consumer banking market within a framework of Shari'ah compliance.

For the purposes of explanation and not to narrow the scope of the present invention, the following describes an example of a financial instrument in accordance with the principles of the present invention.

### EXAMPLE

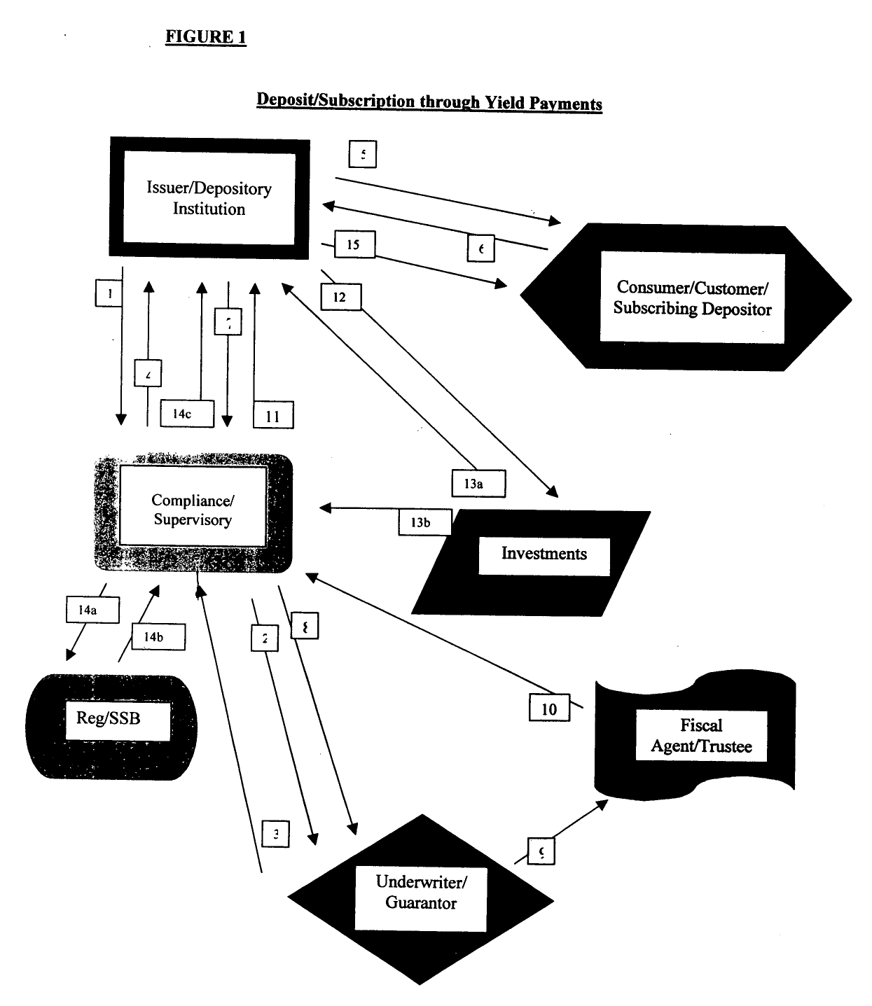

Referring first to FIG. 1, a methodological schematic depicting a general overview of a consumer deposit/subscription through yield payments process in accordance with the principles of the present invention is seen. A banking or funds depository institution is created or otherwise nominated (“Issuer”) who issues the financial instruments. In addition to issuing the financial instruments, the Issuer makes the offering for the purpose of attracting Islamic consumer investments in the form of deposits, and subsequently manages and implements the proceeds of the sale of the financial instruments in a manner consistent with the investment criteria established related to that certain offering profile (the “Investments”). The Issuer creates a document that provides the potential consumer/customer with a required description of and disclosure related to the nature of the financial instrument being offered for sale (“Offering Memorandum”). The Issuer provides (101) the Offering Memorandum and supporting documentation to a third party compliance and supervisory entity(s) which would consist of a Shari'ah Supervisory component, a financial technology administrative networking component, and a professional services (legal counsel, auditor) component (or any combination thereof) for review and compliance evaluation of the offering structure and assistance in coordination of networked guarantors, as the need may arise.

The Shari'ah Supervisory Board component (the “SSB”) of the compliance/supervisory entity may consist minimally of two Islamic Scholars and an Islamic Banking expert, in order to meet the auditing requirements of the Auditing and Accounting Office of Islamic Financial Institutions (the “AAOIFI”). The SSB reviews the Issuer's proposed financial instrument issuance strategy and is responsible for monitoring the Issuer's operations and issuance of requisite certifications as to Shari'ah (Islamic) investment compliance throughout the life of the financial instruments. The financial technology administrative component functions as an administrative outreach of the administrator of the financial technology of the present invention and assists in the coordinated networking of the operation mechanisms required to aid in organizing inter-institutional repurchase guarantees amongst users of the financial technology. The legal and auditing components of the compliance and supervisory entity may be managed independent of the other components through the Issuer's own professional services relations. Alternatively, the legal and auditing components may be aided via a centralized entity which is organized to aid the financial technology users in the consistent deployment of the financial technology. Legal advisors opine as to matters concerning the operation of the portfolios and administration of the operations of the Issuer in compliance with applicable jurisdictional requirements and requisite legal and tax opinions required to underlie the Offering Memorandum. An auditing component (“Auditor”) affords the Issuer with a comprehensive and Shari'ah (Islamic) compliant accounting body upon which the SSB and the consumer depositors/subscribers may place reliance. The Auditor preferably should specialize in matters of Islamic finance.

As applicable, each of the aforementioned entities issues (102) its respective certifications and/or opinions in regard to the means by which financial instruments are made available for subscription to consumers via the Issuer's banking or depository institution (“Offering”). A complete description of the financial instruments proposed for issuance, and such certification and opinions are thereafter incorporated into the final Offering Memorandum. The consumer investment units (“Consumer Investment Units”) are the Shari'ah (Islamic) compliant financial instruments to be issued and sold in accordance with the principles of the present invention. Additionally, the administrative component within the compliance/supervisory entity will notify candidate guarantors of the Issuer's scheduled Offering such that a par value repurchase may be agreed by a third party guarantor on behalf of the Issuer at a future date.

More specifically, an underwriter/guarantor (“Underwriter/Guarantor”) is engaged for the issuance of a third party guarantee for the purposes of fiscally supporting the proposed repurchase of the consumer financial instruments at the close of the term of the financial instruments—that period between the date of subscription and the scheduled date of redemption of the Consumer Investment Units (“Depository Term”). A banking institution (“Fiscal Agent/Trustee”) acts as the administrator for the issuance of the Consumer Investment Units. The Fiscal Agent/Trustee can be a substantial banking or financial institution having a credit agency rating of sufficient quality to meet minimal rating criteria set forth by the nominated credit rating agency which rates the Consumer Investment Units. The Guarantee is preferably organized as a standby letter of credit which becomes available for draw by the Fiscal Agent/Trustee in the event that the Fiscal Agent/Trustee requires further financial support for its repurchase of the financial instruments at the Depository Term as agreed (“Repurchase Guarantee” or “Guarantee”). The Guarantee is issued as the basis of credit enhancement of the Consumer Investment Units for the purposes of creating a “value preserved” security as interpreted by the credit rating agency. As a factor of Shari'ah compliance, the Guarantee is not technically a guarantee of fiscal performance of the Consumer Investment Unit itself, but rather a Guarantee of specific performance under a repurchase requirement (the “Repurchase Agreement”) constituted by the fiscal agency agreement.

The proposed guarantors of the Issuer's Consumer Investment Unit Offering notify the Compliance/Supervisory entity of their commitment to guarantee repurchase of the Consumer Investment Units (103). The Compliance/Supervisory entity notifies Issuer of commitments received to repurchase the Consumer Investment Units, and Issuer commences Offering per a pre-approved schedule (104).

The Offering Memorandum and all supporting documentation for the Consumer Investment Units are made available (105) by the Issuer to the proposed consumers/subscribers as customers of the Issuer as a banking/depository institution. The Issuer, in this case, acts as its own placement agent, although a third party placement agent could be designated by Issuer. The Issuer may make its Offering available to its customers in a variety of ways, including but not limited to mailings, document review/inspection on premises, upon request or any other compliant manner. While the target market for the Consumer Investment Units consists of Islamic consumers that are seeking a secure depository environment for their funds (“Consumer/Subscriber”), the principles of the present invention are not so limited. The Issuer may issue physical certificates for the Consumer Investment Units. Alternatively, the Consumer Investment Units may be administered via a Book-Entry Only System as an alternative delivery method to the issuance of physical certificates for each of the definitive Consumer Investment Units purchased in accordance with the standard practices applied by the Depository Trust Company, Euroclear or other like entities or agencies.

The Consumer/Subscriber agrees (106) to purchase the Consumer Investment Units by deposit of its funds to the designated subscription depository account of the Issuer pursuant to the Issuer's subscription agreement (“Subscription Agreement”). The Issuer's Subscription Agreement defines the terms and conditions of the subscription of and investment in the financial instrument. The Issuer's Subscription Agreement further details the terms and conditions of repurchase of the financial instruments by an acceptable third party banking institution, as the case may be, from the Consumer/Subscriber at an agreed value and at a future date not later than the term of the Consumer Investment Units (the “Underwriter/Guarantor”). The subscription depository account (“Holding/Depository Account”) functions as a holding account for proceeds from a subscription (“Subscription Proceeds”) pending the scheduled receipt by the Issuer's nominated Fiscal Agent/Trustee of a corresponding value of acceptably formatted letters of credit (as the “Repurchase Guarantee”) in support of the Fiscal Agent/Trustee's par value repurchase of the Consumer Investment Units thus sold. The Holding/Depository Account is managed as a non-interest bearing account and the proceeds deposited thereto are not eligible for deployment by the Issuer into any Investment until such time as an applicable Repurchase Guarantee(s) is issued.

Notice of the subscription is delivered to the Compliance/Supervisory entity (107) and the Compliance/Supervisory entity notifies Underwriter/Guarantor of the required issuance of the scheduled Repurchase Guarantee (108). The Guarantee will be instructed for delivery to a safekeeping account established at the Fiscal Agent/Trustee's institution for the purposes of accepting and holding the Guarantee(s) on behalf of the Consumer/Subscribers (“Custodial Account”). The delivery of the Guarantee to the Custodial Account directly supports the Fiscal Agent/Trustee's repurchase of the financial instruments at the conclusion of the Depository Term.

The Underwriter/Guarantor will deliver (109) its Repurchase Guarantee(s) for face value equal to the par value of the outstanding or scheduled value of Consumer Investment Units being covered by such Guarantee to the Fiscal Agent/Trustee that acts as the administrator for the repurchase of the financial instruments on behalf of the Issuer's customer/Consumer/Subscriber. The Fiscal Agent/Trustee will notify Issuer and Compliance/Supervisory entity of its custody of the Guarantees (110) via issuance of its custodial receipt or such other comparable mechanism which identifies deposits of the requisite Guarantees to the Fiscal Agent/Trustee's designated custodial account (“Custodial Safekeeping Receipt”).

The Compliance/Supervisory entity will reconfirm the Fiscal Agent/Trustee's custody of Guarantee(s) in support of the Consumer Investment Unit repurchase, thereby enabling the Issuer to deploy a value of Consumer Investment Unit proceeds equal to the face value of Guarantees then held by Fiscal Agent/Trustee (111). Against the Issuer's receipt of reconfirmation from Compliance/Supervisory entity as to Guarantee custody, funds are freely available for Investment by the Issuer. The Issuer will begin deploying funds (112) into suitable Investments in accordance with the described use of proceeds as set forth in the Offering Memorandum.

As a means of administering Investment deployment, the Issuer may elect to transfer funds now freely available for deployment to a separate account (“Investment Account”), thereby segregating available funds to permit the timely and documented withdrawals of proceeds in support of the Issuer's commencement of its scheduled Investments. By way of example and not limitation, such Investments may include any SSB approved, Shari'ah compliant investment operation or project, including but not limited to energy markets, equipment leasing, real estate, manufacturing, mortgages, and warehousing.

Over the course of the Depository Term, any earnings on the Investments, respectively, will be paid in or otherwise collected (113a) by the Issuer pursuant to the specific terms of investment applicable to a given Investment in support of a calculation and declaration of yield on the Consumer Investment Units. Subject Investments will report (113b) required financial and compliance data to the Compliance/Supervisory entity as agreed, inclusive of data evidencing Shari'ah compliance.

Also, over the course of the Depository Term, reporting data may be provided to certain regulatory bodies or agencies (114a), inclusive of the Compliance/Supervisory entity's SSB, in order to assure good standing of Investments in relation to Issuer's compliant status; any regulatory/SSB entity that is entitled to or required to receive such information as the basis to confirm regulatory compliance of Investments to Compliance/Supervisory entity (114b); and Compliance/Supervisory entity provides (114c) Investment reports and compliance certifications as to standing of Investments to Issuer. Based upon the performance of the Investment portfolio arising from the deployment of proceeds made available via the sale of the Consumer Investment Units, the Issuer periodically makes a declaration of composite yield (115), if any, for the Investments and remit any such yield payment in favour of the Consumer/Subscriber on a pro rata basis, representative of the value of Consumer Investment Units purchased. Any such yield payment is remitted in favor of a non-interest bearing, depository account at the Issuer's institution designated for the receipt and acceptance of yield payments from specific Investments (“Yield Account”).

In order to cause the issuance of the Guarantee, a balance between risk and guarantor benefit is struck. Dependent upon the sophistication of the networked application of the present invention, a variety of approaches to induce Guarantor participation may be undertaken. Three possible example approaches to engaging suitable repurchase Underwriter/Guarantors are examined.

First, in its simplest form, an Underwriter/Guarantor will evaluate the design of the Investment eligibility criteria for the Issuer's Investment portfolio to assess whether it is broad enough to foster certain investment flexibility on the part of the Issuer, on the one hand; while remaining specific enough, on the other hand, to permit the Underwriter/Guarantor to be comfortable that the aggregate value of the Issuer's cash reserves and the Issuer's subject Investments' asset valuation will support a certain minimum Investment portfolio valuation at the earliest possible date for draw on the Guarantee. This is the future date certain set for repurchase of the Consumer Investment Units by the Fiscal Agent/Trustee at the conclusion of the Depository Term.

Ideally, the formulation of an acceptable credit structure is accomplished with a candidate Underwriter/Guarantor by way of the negotiation and definition of several mechanisms. Initially, a specific Investment eligibility criteria serves as the “blanket” Investment policy of the Issuer and credit policy of the Underwriter/Guarantor related to the compilation of the Investment portfolio. Solely for the purposes of example, specific formulas may be included in that eligibility criteria which identify minimum required asset ratios when compared to total Investment in a subject project, specific minimum historical performance ratios for a given candidate Investment or project, required percentage-based cash reserve requirements which may be deposited with and held by the Underwriter/Guarantor during the life of a subject Investment, the creation of a sinking fund to directly offset and compensate the Underwriter/Guarantor for the maximum perceived potential loss of asset value during the life of a given Investment, and/or the establishment of a minimum blended asset ratio to total funds invested.

Additionally, mechanisms include the establishment of an Investment draw schedule during the Depository Term which may require certain minimum cash values be maintained on Issuer's accounts up to the date of scheduled Consumer Investment Unit repurchase; the allocation of a certain percentage of Investment earnings, profits or yields arising from the Investments during the Depository Term into a dedicated Guarantee reserve account to be held by the Underwriter/Guarantor and drawable expressly by the Fiscal Agent/Trustee in support of certain payments to be made by the Fiscal Agent/Trustee under its Repurchase Agreement as supplemented and supported by the Underwriter/Guarantor's Guarantee; and/or the granting of a certain security interest in unrelated or additional collateral deemed acceptable to the Underwriter/Guarantor.

The basis of negotiating and securing the Guarantee may include any one or more of the aforementioned mechanisms or such other mechanism as a specific Underwriter/Guarantor may warrant and a specific Issuer may grant. In any event, in securing the Guarantee, the conservative formulation of an Investment criteria is established which sufficiently supports the valuation of the Issuer's total available assets at the Depository Term, inclusive of the Investment portfolio itself, such that the Underwriter/Guarantor may issue its Guarantee in support of the Fiscal Agent/Trustee's performance on its repurchase undertaking to the Consumer/Subscribers. The Underwriter/Guarantor is not being engaged for the purposes of guaranteeing specific performance of the Consumer Investment Units, lest the Guarantee be potentially deemed non-compliant with Shari'ah principles.

Additionally, to be Shari'ah compliant the Guarantee arises from an examination of the means by which the Underwriter/Guarantor may be compensated for the issuance of its Guarantee. An Underwriter/Guarantor is designated that may consist of a single banking or financial institution, one or more banking or financial institutions participating in a syndication, or a networked extension of an organized administration of the present invention by the Compliance/Supervisory entity within an established framework of Shari'ah compliant performance guarantee mechanisms or policies. In any of the foregoing cases, when the Underwriter/Guarantor is an institution having an acceptable investment grade rating, the rating of the Underwriter/Guarantor will generally become the basis by which the creditworthiness of the Consumer Investment Units is thus measured.

In this example, the Guarantee takes the form of a letter of credit, preferably a standby letter of credit, which becomes payable upon default under the provisions of Consumer Investment Unit repurchase or the Repurchase Agreement with the Fiscal Agent/Trustee. Customarily, a banking institution will charge certain fees (“Issuance Fees”) related to the issuance of a letter of credit or similar undertaking. In order for the Guarantee to be and remain Shari'ah compliant, the Underwriter/Guarantor agrees to waive the collection of Issuance Fees related to the Guarantee, effectively issuing the letter of credit without consideration. Alternatively, the Underwriter/Guarantor instead could potentially benefit by discounting the face value of the Guarantee upon issuance or by way of the exploitation of other potential revenue centers available to it related to the operations of the Issuer.

The foregoing generally identifies the specific performance obligation which is being supported by the Guarantee and the considerations which must be weighed in order to satisfactorily cause the issuance of the Guarantee. These principles may be readily applied to a varied selection of Underwriters/Guarantors in compliance with Shari'ah principles. In one preferred embodiment, the Underwriters/Guarantors operate within the banking industry. At the Issuer's option, however, an Underwriter/Guarantor may be engaged which consists of a single international banking institution, one or more international banking institutions participating in a syndication or consortium, or any administrative combination of the above. However, in general, the use of a networked underwriting and guarantee mechanism as administered by a third party Compliance/Supervisory entity such that a group of banking institutions operate under a cooperation agreement is potentially the most efficient means of affecting the consistent and mutually, but indirectly beneficial, issuance of scheduled Guarantees. Under such an arrangement, organized groupings of financial institutions may from time to time act as both Consumer Investment Unit Issuers and Underwriter/Guarantors, respectively, such that each may benefit from the fiscal balance achieved amongst themselves. Also, in this example, the risks associated with a given Consumer Investment Unit issuance may be easily defrayed among a variety of Underwriter/Guarantors. All banking institutions participating in this networked organization have a certain minimum financial standing or rating such that a blended rating for the financial instruments which are ultimately supported by the Guarantees to be issued by the network may be reasonably determined.

Alternatively, and somewhat less efficiently, the syndication process described above may be undertaken directly by the Issuer. The Issuer may create a banking consortium for the issuance of multiple letters of credit, constituting the Guarantees, which aggregate sum of their respective face values will total the par value of all outstanding Consumer Investment Units. Preferably, in the event that the Issuer organizes multiple Guarantees which support performance under the Repurchase Agreement, all Guarantees would preferably be issued concurrently such that the repurchase obligation of the Consumer Investment Units is viewed collectively and consistently as to operations and default provisions in the event of a default. Although potentially open to interpretation, the operation of all individual Guarantees concurrently assures certain parity between or equality among the outstanding Consumer Investment Units which is desirable.

As a further alternative, the Issuer could undertake to cause the engagement of one Underwriter/Guarantor in support of a specific Consumer Investment Unit issuance. This alternative can potentially be successfully implemented by applying comparable underwriting, security or collateralization mechanisms to those profiled above and by negotiating an alternative means of inducing the participation of the Underwriter/Guarantor in a Shari'ah compliant manner for the issuance of the required Guarantee.

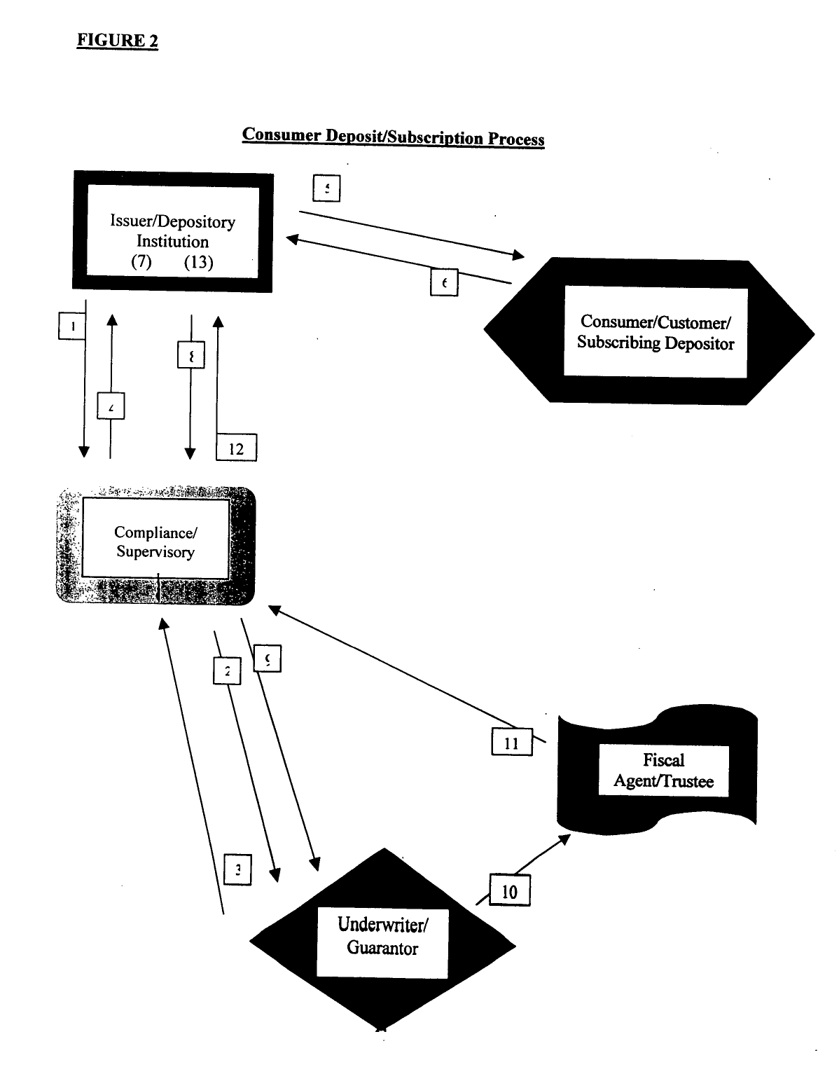

Referring now to FIG. 2, a methodological schematic showing details of a depository/subscription process in accordance with the principles of the present invention is seen. Based upon market demand from Consumer/Subscriber of the Issuance, the Issuer provides (201) the Offering Memorandum and supporting documentation, inclusive of designation of Fiscal Agent/Trustee for the Consumer Investment Unit series, to the Compliance/Supervisory entity for recording of the scheduled Consumer Investment Unit series in support of the desired method of networked Underwriter/Guarantor repurchase guarantee facilitation, and notice of issuance to the designated Shari'ah Supervisory Board, either as an independent entity or part of the Compliance/Supervisory entity.

The Compliance/Supervisory entity provides notice (202) of issuance to candidate Underwriters/Guarantors for scheduling of the respective underlying Guarantees in support of Consumer Investment Unit repurchase at par upon Consumer Investment Unit default or scheduled term of each applicable Consumer Investment Unit. One or more Underwriters/Guarantors submit (203) notification to Compliance/Supervisory entity of their commitment to issue their respective Guarantee in support of the scheduled Consumer Investment Unit series to be issued by Issuer.

The Compliance/Supervisory entity notifies (204) Issuer and designated Fiscal Agent/Trustee for the Consumer Investment Unit series of schedule of underlying Guarantee issuance as agreed and committed by Underwriters/Guarantors. This enables issuance and delivery of Consumer Investment Units per pre-approved schedule by Issuer. Upon request, Offering Memorandum, Subscription Agreement and all supporting documentation is tendered (205) by Issuer to Consumer/Subscriber as the subscriber for all or any portion of the Consumer Investment Unit allocation.

Following the completion of normal bank due diligence on Consumer/Subscriber, Consumer/Subscriber agrees (206) to purchase desired Consumer Investment Units from Issuer/Depository Institution. Consumer/Subscriber executes Issuer's Subscription Agreement, inclusive of corresponding funds origin warranties, and effects the deposit of purchase proceeds to the designated Holding/Depository Account at the Issuer/Depository Institution. The amount accepted for subscription will not exceed the maximum value of Guarantees scheduled and agreed for issuance by Underwriter/Guarantor per prior agreement with Issuer.

Subscription proceeds are maintained (207) in a non-depleting reserve account, pending issuance and delivery of the corresponding Guarantee to the Custodial Account of the Fiscal Agent/Trustee for the Consumer Investment Unit series then being subscribed. Notice of subscription and subscription amount held in reserve is provided (208) by Issuer to Compliance/Supervisory entity. The Compliance/Supervisory entity advises (209) Underwriter/Guarantor of pending subscription which confirms Issuer's call for issuance of the scheduled Guarantee(s).

The Underwriter/Guarantor causes the issuance of its scheduled and agreed Guarantee(s) (210) covering the par value of the outstanding Consumer Investment Units being subscribed (which is also equal to the value of the proceeds deposited to the Holding/Depository Account of the Issuer) and delivers Guarantee(s) to the custody of the Fiscal Agent/Trustee. Fiscal Agent/Trustee confirms (211) its custody of scheduled Guarantee(s) in its designated Custodial Account to Compliance/Supervisory entity in support of the repurchase of the Consumer Investment Units in the series.

Compliance/Supervisory entity advises (212) Issuer of Fiscal Agent's/Trustee's custody of the Guarantee(s) in support of the par value repurchase of the Consumer Investment Units being subscribed, thereby enabling the Issuer's release, Investment or deployment of a value of Subscription Proceeds from its Holding/Depository Account equal to a maximum aggregate value of the Guarantee(s) then in the custody of the Fiscal Agent/Trustee. Issuer transfers funds (213) to its designated Investment Account pending subsequent investment in qualified and permitted Investments in accordance with the investment eligibility requirements set forth in the Offering Memorandum and supporting documentation, which Investments constitute the Investment portfolio.

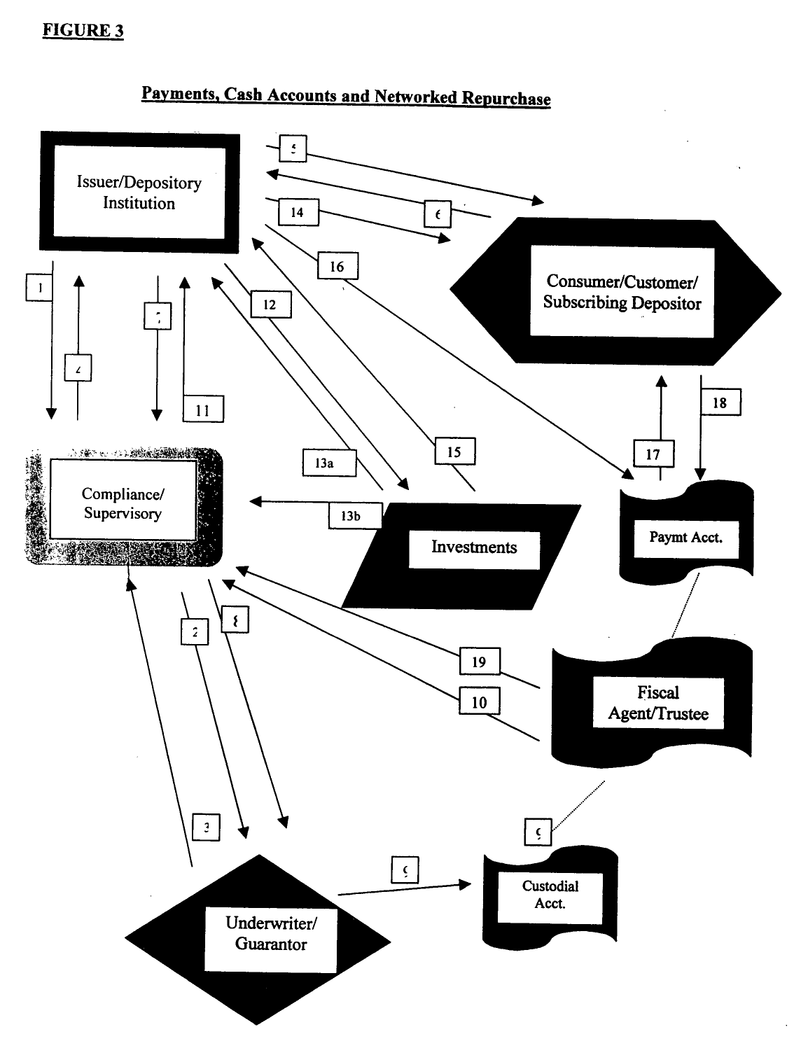

Referring now to FIG. 3, a methodological schematic showing payments, cash accounts, and a Networked Consumer Investment Unit repurchase in accordance with the principles of the present invention is seen. Issuer provides (301) Offering Memorandum and supporting documentation, inclusive of designation of Fiscal Agent/Trustee for the Consumer Investment Unit series, to third party Compliance/Supervisory entity for recording of Consumer Investment Unit series pertaining to Underwriter/Guarantor facilitation and notice to designated Shari'ah Supervisory Board.

Compliance/Supervisory provides notice of issuance (302) to candidate Underwriters/Guarantors for scheduling of the respective underlying Guarantees in support of Consumer Investment Unit repurchase by Underwriter/Guarantor at par upon Consumer Investment Unit default or the scheduled term of the Consumer Investment Units. In response to notice received, one or more Underwriters/Guarantors submit (303) notification to Compliance/Supervisory entity of commitment to issue their respective Guarantee(s) in support of the scheduled Consumer Investment Unit series to be issued by Issuer.

Compliance/Supervisory entity notifies (304) Issuer and designated Fiscal Agent/Trustee for the Consumer Investment Unit series of schedule of underlying Guarantees to be issued as agreed and committed by Underwriters/Guarantors, thereby permitting issuance of Consumer Investment Units per approved schedule. Upon request, Offering Memorandum, Subscription Agreement and all supporting documentation are made available (305) by Issuer to Consumer/Subscriber as the Subscriber in support of all or any portion of the Consumer Investment Unit allocation then approved for issuance and repurchase.

Following normal bank due diligence on the proposed subscriber, Consumer/Subscriber agrees (306) to purchase all or a portion of the scheduled Consumer Investment Units from Issuer/Depository Institution per Issuer's Subscription Agreement which includes certain corresponding funds origin warranties by the subscriber. Consumer/Subscriber deposits purchase proceeds to the designated account at the Issuer/Depository Institution up to the maximum aggregate value of Guarantees scheduled for issuance by respective Underwriter/Guarantor(s).

Notice of subscription and subscription amount then deposited to the designated Holding/Depository Account of the Issuer is provided (307) to Compliance/Supervisory entity. Compliance/Supervisory entity advises (308) Underwriter/Guarantor of subscription which confirms Issuer's call for issuance of the scheduled Guarantee(s).

The Underwriter/Guarantor causes the issuance (309) of its scheduled and agreed Guarantee(s) covering the par value of the outstanding Consumer Investment Units and delivers Guarantee(s) to the designated Custodial Account of the Fiscal Agent/Trustee for the Consumer Investment Unit series. Fiscal Agent/Trustee confirms (310) its custody of scheduled Guarantee(s) in support of Consumer Investment Unit series to Compliance/Supervisory entity via issuance of custodial receipt or such other like or acceptable method.

Compliance/Supervisory entity advises (311) Issuer of Fiscal Agent/Trustee's custody of Guarantee, thereby enabling the Issuer's release, investment or deployment of a value of Subscription Proceeds equal to a maximum aggregate value of the Guarantee(s) then in the custody of the Fiscal Agent/Trustee. Issuer selects and affects (312) the scheduled Investments in accordance with the investment eligibility requirements set forth in the Offering Memorandum and supporting documentation which Investments then constitute the Investment portfolio.

Over the course of the Investment Term, any earnings on the Investments, respectively, will be paid in or otherwise collected by (313a) the Issuer pursuant to the specific terms of Investment applicable to a given Investment in support of a calculation and declaration of yield on the Consumer Investment Units. All companies, institutions or entities that have received Investment Proceeds and which constitute the Investments in the Investment portfolio will report required financial and compliance data (313b) to Compliance/Supervisory entity as agreed, inclusive of data evidencing Shari'ah compliance.

The Issuer periodically makes a declaration of composite yield (314), if any, for the Investments and remits any such yield payment in favour of the Consumer/Subscriber on a pro rata basis, representative of the value of Consumer Investment Units purchased. Per the agreed liquidation or Investment termination provisions of the Issuer's Investment agreements with the subject Investments, Issuer collects (315) certain amounts from Investments intended to cover repurchase costs and expenses associated with the Consumer Investment Units. Issuer deposits (316) required repurchase amounts to Fiscal Agent/Trustee's designated Payment Account. This depository function, although not referenced in the present example, may also be implemented under a segregated Payment Account with the Issuer under specific arrangement with the Fiscal Agent/Trustee. Fiscal Agent/Trustee distributes (317) payments from its designated Payment Account in amounts equal to the par value of the Consumer Investment Units then held by the Consumer/Subscriber, respectively, thereby effecting a scheduled repurchase of the Consumer Investment Unit series then being closed out at the conclusion of the Depository Term. In response to receipt of payment, Consumer/Subscriber surrenders (318) repurchased Consumer Investment Units to Fiscal Agent/Trustee, and Fiscal Agent/Trustee disposes of repurchased units pursuant to its agreement with the Issuer. Notice is provided (319) to Compliance/Supervisory entity of the Consumer Investment Unit series' compliant and scheduled repurchase and retirement.

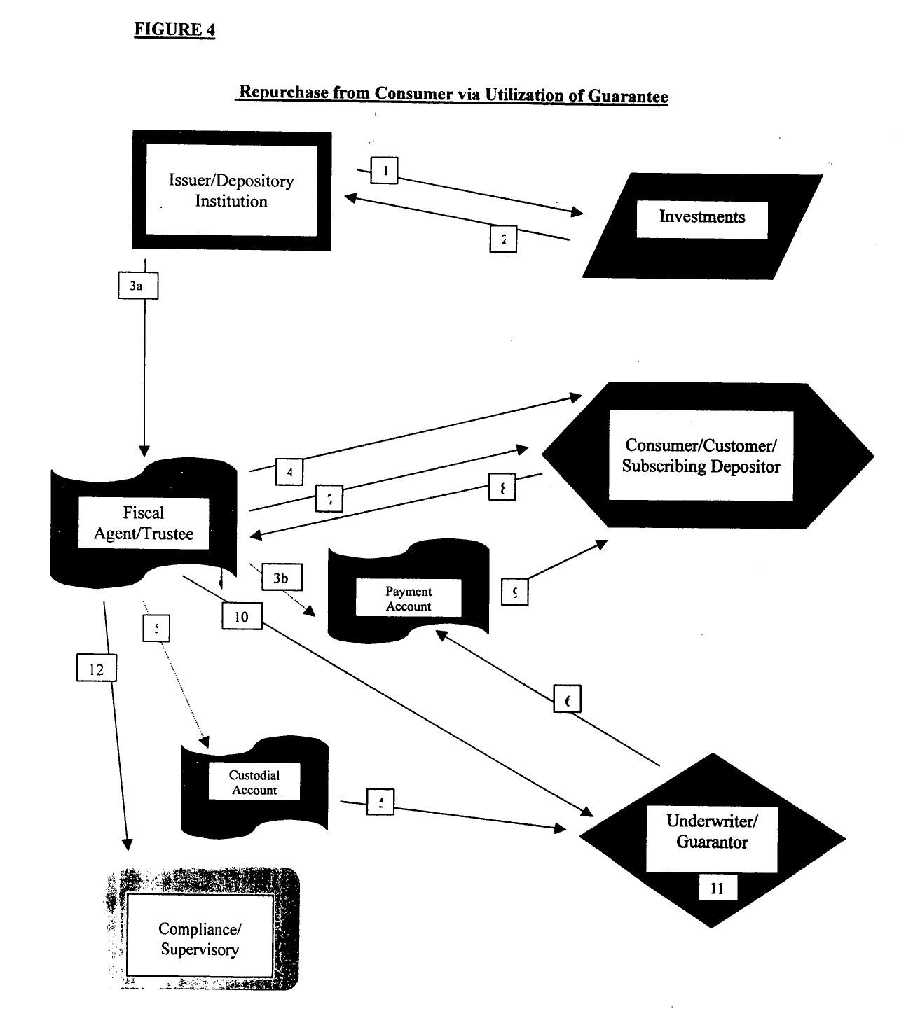

Referring now to FIG. 4, a methodological schematic showing repurchase via utilization of the Guarantee in accordance with the principles of the present invention is seen. As necessary prior to the conclusion of the Depository Term of the Consumer Investment Units, Issuer tenders (401) its instructions for liquidation of a minimum of the original investment amount or such other amount as was agreed with each of its respective Investments as such constitute the Investment portfolio just prior to the conclusion of the Depository term.

In response, Investments, respectively, remit (402) payments to Issuer per their agreements with Issuer on or about the conclusion of the Depository Term. For the purposes of this example, available proceeds collected are not sufficient to cover or otherwise fully offset the scheduled par value repurchase of the Consumer Investment Units then outstanding in the Series.

Issuer provides (403a) notice of the amount collected to Fiscal Agent/Trustee and makes payment of available proceeds in support of Consumer Investment Unit repurchase by the Fiscal Agent/Trustee on or about the scheduled close of the Depository Term; and Fiscal Agent/Trustee credits (403b) the amount remitted by Issuer to a designated Payment Account.

Fiscal Agent/Trustee advises (404) Consumer/Subscribers of Fiscal Agent/Trustee's intent to draw upon one or more of the Guarantee(s) as the basis to support and satisfy its repurchase obligation for the Consumer Investment Units then outstanding or otherwise not able to be repurchased with available proceeds in the Payment Account.

Fiscal Agent/Trustee, on behalf of the Consumers/Subscribers, presents (405) its demand for payment of an amount equal to the repurchase shortfall plus any permitted fees or expenses to the Underwriter/Guarantor pursuant to the terms and conditions of the Guarantee(s) then being drawn. Provided the demand for payment was presented compliantly, the Underwriter/Guarantor will remit (406) its payment to the designated payment Account of the Fiscal Agent/Trustee.

Upon the receipt of proceeds drawn under the Guarantee(s), Fiscal Agent/Trustee calls for presentation (407) of outstanding Consumer Investment Units at the counters of the Fiscal Agent/Trustee or its nominee for repurchase. Although not described in the present example, the Fiscal Agent/Trustee may elect to nominate the Issuer for acceptance of all surrendered Consumer Investment Units being repurchased.

Consumer/Subscribers surrender (408) their Consumer Investment Units pursuant to Fiscal Agent/Trustee's instruction. Fiscal Agent/Trustee repurchases (409) the outstanding Consumer Investment Units by payment from the designated Payment Account to the Consumer/Subscribers.

Fiscal Agent/Trustee will (410), if required, deliver the duly repurchased Consumer Investment Units to the Underwriter/Guarantor or pursuant to instructions received. The Underwriter/Guarantor will take (411) whatever actions it deems necessary with reference to the Issuer and the Consumer Investment Units to recoup or otherwise offset payments made under its Guarantee. Fiscal Agent/Trustee will notify (412) the Compliance/Supervisory entity of any draws, payments or collections made under any Guarantee(s) in relation to the Consumer Investment Unit series. The Compliance/Supervisory entity will subsequently utilize this data with reference to future proposed or scheduled issuances of Consumer Investment Units by the Issuer.

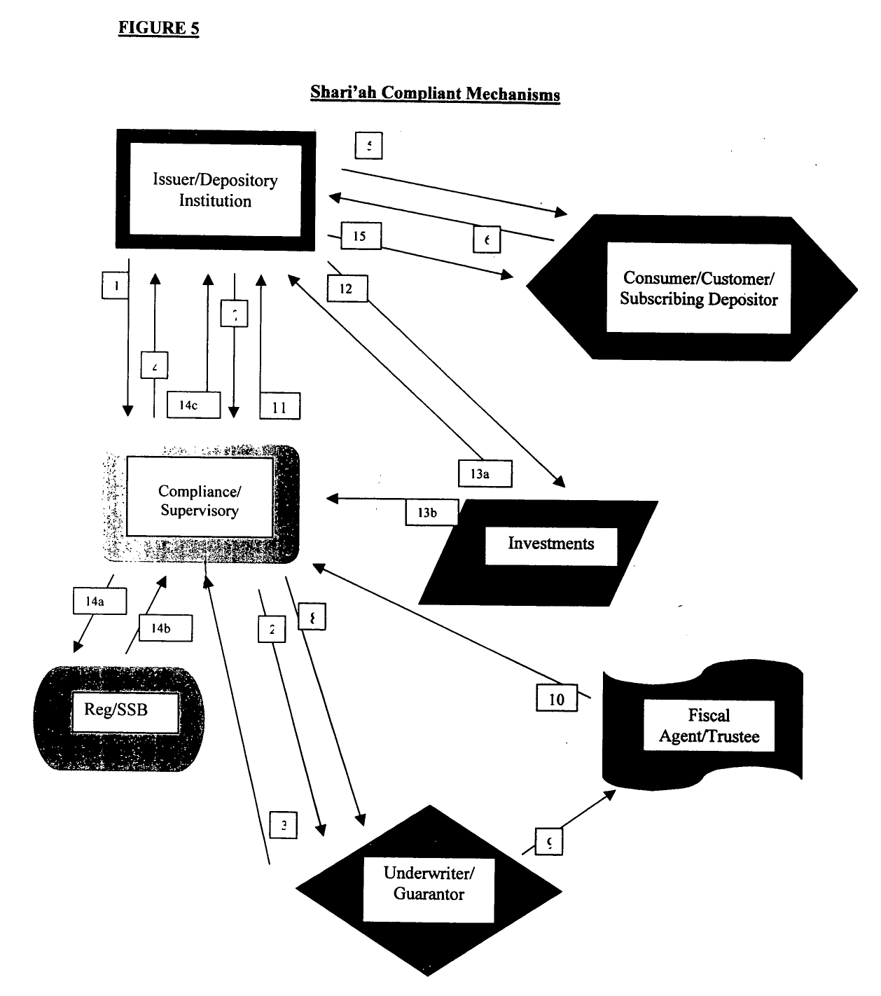

Referring now to FIG. 5, a methodological schematic showing Shari'ah compliant mechanisms in accordance with the principles of the present invention is seen. Issuer provides (501) Offering Memorandum and supporting documentation, inclusive of designation of Fiscal Agent/Trustee for the Consumer Investment Unit series, to third party Compliance/Supervisory entity for recording of Consumer Investment Unit series pertaining to Underwriter/Guarantor facilitation and review by designated SSB. The SSB supervises, monitors and advises as to all matters of Islamic compliance involving the Issuer's issuance and sale of the Consumer Investment Units, on-going operations, and financial interests concerning the calculation and payment of yield, financial risk management, and the underwriting and repurchase of the Consumer Investment Units at the conclusion of the Depository Term. Prior to issuance of the Consumer Investment Units by Issuer, the SSB, either directly or via the Compliance/Supervisory entity will review all documentation and data provided by the Issuer related to the Offering and, providing all is compliant, will issue its certification of compliance with Shari'ah investment and financial principles (a fatwa) which is incorporated into the Offering Memorandum and related documentation by the Issuer. The SSB functions may be part of the Compliance/Supervisory functionality or may be handled via a third party dedicated SSB organizational entity. For the purposes of the present example, the organizational structure of the SSB related to the Compliance/Supervisory entity is recorded as an independent entity.

Compliance/Supervisory provides (502) notice of issuance to candidate Underwriters/Guarantors for scheduling of the respective underlying guarantees in support of Consumer Investment Unit repurchase by Underwriter/Guarantor at par upon Consumer Investment Unit default or scheduled term. In response to notice, one or more Underwriters/Guarantors submit (503) notification to Compliance/Supervisory entity of commitment to issue their respective Guarantee(s) in support of the repurchase of the scheduled Consumer Investment Unit series to be issued by Issuer.

Compliance/Supervisory entity notifies (504) Issuer and designated Fiscal Agent/Trustee for the Consumer Investment Unit series of the schedule of underlying Guarantees as agreed and committed by Underwriters/Guarantors, thereby permitting issuance of Consumer Investment Units per pre-approved schedule. Upon request, Offering Memorandum, Subscription Agreement and all supporting documentation is made available (505) by Issuer to Consumer/Subscriber for all or any portion of the Consumer Investment Unit allocation and who are likely of Islamic belief and practice.

Following normal bank due diligence by the Issuer, Consumer/Subscriber agrees (506) to purchase all or a portion of the Consumer Investment Units from Issuer/Depository Institution per Issuer's Subscription Agreement and corresponding funds origin warranties. The Consumer/Subscriber deposits its purchase proceeds to the designated Shari'ah compliant, non-interest bearing Holding/Depository Account at the Issuer/Depository Institution. Notice of subscription and subscription amount as deposited to the Issuer's designated Holding/Depository Account is provided (507) to Compliance/Supervisory entity.

Compliance/Supervisory entity advises (508) Underwriter/Guarantor of subscription which confirms Issuer's call for issuance of the scheduled Guarantees. The Underwriter/Guarantor will cause (509) the issuance of its scheduled and agreed Guarantee(s) covering the par value repurchase of the outstanding Consumer Investment Units and delivers guarantee(s) to the Fiscal Agent/Trustee. The Underwriter/Guarantor does not charge an Issuance Fee for the Guarantee. In order for the Guarantee to be and remain Shari'ah compliant, the Underwriter/Guarantor must agree to waive the collection of Issuance Fees related to the Guarantee; the Underwriter/Guarantor instead can potentially benefit by the provision of related service functions or by way of other potential revenue centers available to it related to the operations of the Issuer.

Fiscal Agent/Trustee confirms (510) its custody of scheduled Guarantee(s) in support of Consumer Investment Unit series to Compliance/Supervisory entity. Compliance/Supervisory entity advises (511) Issuer of Fiscal Agent/Trustee's custody of Guarantee(s), thereby enabling the Issuer's release, investment or deployment of a value of Subscription Proceeds equal to a maximum value of the Guarantee then in the custody of the Fiscal Agent/Trustee.

Issuer selects and affects (512) the scheduled Investments in accordance with the investment eligibility requirements set forth in the Offering Memorandum and supporting documentation which Investments then constitute the Investment portfolio. Over the course of the Investment Term, any earnings on the Investments will be paid in or otherwise collected by (513a) the Issuer pursuant to the specific terms of investment applicable to a given Investment in support of a calculation and declaration of yield on the Consumer Investment Units. The businesses, operating companies or projects that constitute the Investments will report (513b) required financial and compliance data to Compliance/Supervisory entity as agreed, inclusive of data evidencing Shari'ah compliance. Reporting data is provided (514a) to certain regulatory bodies or agencies, inclusive of Compliance/Supervisory entity's SSB, in order to assure good standing of Investments in relation to Issuer's Shari'ah compliant status. The SSB entity confirms (514b) compliant status of Investments to Compliance/Supervisory entity; and Compliance/Supervisory entity provides (514c) Investment reports and compliance certifications as to Shari'ah compliant standing of Investments to Issuer.

The Issuer periodically makes a declaration of composite yield (515), if any, for the Investments and remit any such yield payment in favour of the Consumer/Subscriber on a pro rata basis, representative of the value of Consumer Investment Units purchased. There is no guarantee of a specific yield, earnings or interest payable to the Subscriber/Investor in relation to the Consumer Investment Units or the Investments.

The Issuer is also required to certify the on-going Shari'ah compliant standing of its Consumer Investment Units to Consumer/Subscribers in conjunction with Shari'ah compliant distributions of yield. As such, during the Depository Term, the SSB will periodically audit and randomly inspect the operations of the Investments to assure that no portion of the operations of the Investments fail to comply with Shari'ah Investment Guidelines and business principles. Against a satisfactory audit and inspection of the documents delivered by the Issuer, the SSB delivers a copy of their updated Shari'ah certification related to the Issuer activities such that copies may be made available to and for the records of the Consumer/Subscribers throughout the balance of the Depository Term.

Thus, a financial instrument in accordance with the principles of the present invention encompasses certain features which make it new and innovative in the Islamic consumer banking market. A financial instrument in accordance with the principles of the present invention makes tangible the philosophical beliefs of Islam within a framework which is conducive to traditional financial thought which is designed to aid a consumer in preserving their savings while potentially generating a minimal yield or earnings thereon. This marriage of ideologies is evident via the overlay of financial practices generally identified in FIG. 5, which demonstrates Shari'ah compliant mechanisms within the consumer banking market, such that an economic bridge is established for the benefit of the Islamic consumer which for the first time aids them in conservatively managing their funds while still maintaining an opportunity to further enhance their collective value.

While the invention has been described with specific embodiments, other alternatives, modifications and variations will be apparent to those skilled in the art. Accordingly, it will be intended to include all such alternatives, modifications and variations set forth within the spirit and scope of the appended claims.

The following Glossary of Terms is set forth for convenience and should not be construed as limiting the scope of the present invention:

### Glossary of Terms

Auditing and Accounting Office of Islamic Financial Institutions (“AAOIFI”): responsible for, among other things, the monitoring and oversight of Islamic banking and investment institutions.

Auditor: The firm to be appointed should specialize in matters of Islamic finance. It should afford the Issuer with a comprehensive and Shari'ah compliant accounting body upon which the Shari'ah Supervisory Board and the investors may place reliance.

Consumer Investment Unit: the Shari'ah (Islamic) compliant investment-grade security to be issued and sold resultant from the application of a financial instrument in accordance with the principles of the present invention.

Consumer/Subscribers: those entities, parties or individuals who purchase the Consumer Investment Units, consisting of Islamic individuals and retail banking customers.

Custodial Account: a safekeeping account established at the Fiscal Agent/Trustee's institution for the purposes of accepting and holding the Repurchase Guarantee(s) for the ultimate benefit of the Subscribers/Investors.

Custodial Safekeeping Receipt: the receipt issued by the Fiscal Agent/Trustee which identifies deposits to the Custodial Account of the Guarantee(s).

Depository Term: the term of the Consumer Investment Units, or that period between the date of subscription and the scheduled date of redemption of the Consumer Investment Units.

Fiscal Agent/Trustee: a substantial international banking institution having a credit agency rating of sufficient quality to meet minimal rating criteria set forth by the nominated credit rating agency which rates the Consumer Investment Units; acts as the administrator for the issuance of the Consumer Investment Units.

Guarantee: the letter of credit, preferably a standby letter of credit, which is issued by the Underwriter/Guarantor in support of the repurchase of the Consumer Investment Units.

Holding/Depository Account: a non-interest bearing, depository account at the Issuer's institution designated for the receipt of proposed Subscription Proceeds prior to the scheduled purchase of the Consumer Investment Units.

Investment: the project or company which is, was or became the intended application or use of the proceeds derived from the sale of the Consumer Investment Units.

Investment Account: a non-interest bearing, depository account designated for the deposit and disbursement of Subscription Proceeds in favor of a certain investment as identified, selected and scheduled by the Issuer.

Issuance Fee: the fee customarily charged by a banking institution or other such entity for the issuance of a letter of credit or other similar undertaking.

Issuer: the banking or financial institution which issues the Consumer Investment Units, makes the Offering for the purpose of attracting consumer deposits and subsequently manages and implements the proceeds of the sale of the Consumer Investment Units in a manner consistent with the investment criteria established related to that certain Offering for which the Consumer Investment Units were issued.

Offering: the means by which the Consumer Investment Units are made available for purchase to the consumer/retail marketplace by the Issuer.

Offering Memorandum: the document which provides the potential investor with a required description of and disclosure related to the nature of the Consumer Investment Units being offered for sale.

Rating Agency: Moody's Investor Services, Standard & Poors, or such other internationally recognized credit rating agency.

Repurchase Agreement: the terms and conditions under which the repurchase of the Consumer Investment Units from the Subscriber/Investors by the Fiscal Agent/Trustee or, as the case may be, an alternative third party, is scheduled at an agreed value and on a future date certain.

Repurchase Guarantee: See “Guarantee”.

Shari'ah Supervisory Board (“SSB”): an advisory board consisting of at least two Islamic Scholars and an expert in the field of endeavor of the Issuer/Investment; alternatively, an SSB may consist of three Islamic Scholars and still meet the auditing requirements of the AAOIFI. The SSB reviews the Issuer's proposed Consumer Investment Unit issuance and underlying investment/business strategy and is responsible for the monitoring of the Issuer's operations and the issuance of requisite certifications as to Shari'ah (Islamic) investment compliance throughout the life of Consumer Investment Unit series.

Subscription Agreement: the agreement which defines the terms and conditions of the subscription of and investment in the Consumer Investment Units.

Subscription Proceeds: the funds which were derived from the sale of the Consumer Investment Units.

Underwriter/Guarantor: This entity may consist of several international banking institutions, or functionally comparable entities; the Underwriter/Guarantor is engaged for the purposes of issuance of its guarantee in support of the repurchase of the Consumer Investment Units at the close of the Depository Term.

Yield Account: a non-interest bearing, depository account designated for the receipt and acceptance of yield payments.

What is claimed is:

1. The method of creating a financial instrument comprising:
creating or nominating an entity which issues consumer investment units;
reviewing the proposed consumer investment units as to Shari'ah (Islamic) investment compliance;
securing a rating of the consumer investment units by a credit rating agency;
providing the financial instrument to certain qualified, candidate retail banking customers as subscribers who may be of Islamic belief and practice;
issuing a guarantee for the benefit of the subscribers payable in the event of default on scheduled financial instrument repurchase; and
monitoring the financial instruments as to Shari'ah (Islamic) investment compliance.

2. The method of creating a financial instrument of claim 1, wherein the step of assembling a Shari'ah Supervisory Board in coordination with a network and thereby increasing the efficiencies and breadth of the Shari'ah compliance review process.

3. The method of creating a financial instrument of claim 1, further including issuing consistently formatted consumer investment units.

4. The method of creating a financial instrument of claim 3, further including developing a secondary market for consumer investment units.

5. The method of creating a financial instrument of claim 1, wherein the step of rating the consumer investment units by a credit rating agency further includes rating the financial instruments by Standard & Poor's, Moody's Investors Service, Inc. or such other recognized credit rating agency acceptable to investors.

6. The method of creating a financial instrument of claim 1, wherein the step of issuing a guarantee for the benefit of the subscribers further includes issuing a letter of credit in support of performance under a repurchase agreement for the financial instrument rather than performance of the financial instrument.

7. The method of creating a financial instrument of claim 1, further wherein an issuance fee is not charged for the guarantee.

8. The method of creating a financial instrument of claim 7, wherein the step of not charging an issuance fee further includes making fees and charges effectively payable in the event that the guarantee is called for payment.

9. The method of creating a financial instrument of claim 7, wherein the step of not charging an issuance fee further includes potentially offsetting any declined issuance fees with bank fees and charges customarily payable related to funds under management.

10. The method of creating a financial instrument of claim 7, wherein the step of not charging an issuance fee for the guarantee further includes discounting the face value of the guarantee to offset fees and charges associated therewith and entering into independent Shari'ah compliant management agreements for funds on deposit.

11. The method of creating a financial instrument of claim 7, wherein the step of not charging an issuance fee for the guarantee further includes offsetting any declined issuance fees and charges with compensating balances and funds (other than those arising from subscription proceeds) on deposit under Shari'ah compliant management agreements.

12. The method of creating a financial instrument of claim 1, wherein the step of issuing a guarantee for the benefit of the subscribers further includes supporting the repurchase of the consumer investment units at an agreed price at the close of the investment term via the issuance of the third party guarantee.

13. The method of creating a financial instrument of claim 1, wherein the step of issuing a guarantee for the benefit of the subscribers further includes causing the issuance of the guarantee for face value equal to the par value of the investment units, unless a discount thereof is otherwise agreed.

14. The method of creating a financial instrument of claim 1, further wherein the step of monitoring as to Shari'ah (Islamic) investment compliance further includes periodically auditing and randomly inspecting operations to assure that no portion of the operations fail to comply with Shari'ah Investment Guidelines and business principles.

15. The method of creating a financial instrument of claim 1, further wherein the step of monitoring as to Shari'ah (Islamic) investment compliance further includes making a copy of an updated Shari'ah certification available to and for the records of the Subscribers.

16. The method of creating a financial instrument comprising:
creating or nominating an entity which issues consistently formatted consumer investment units;
reviewing the proposed consumer investment units as to Shari'ah (Islamic) investment compliance;
issuing a guarantee for the benefit of the subscribers payable in the event of default on scheduled financial instrument repurchase;
developing a secondary market for consumer investment units; and
monitoring the financial instruments as to Shari'ah (Islamic) investment compliance.

17. The method of creating a financial instrument of claim 16, further including utilizing a Shari'ah Supervisory Board to assure the Shari'ah compliant issuance, administration, guarantee, and operation of the consumer investment units.

18. The method of creating a financial instrument of claim 16, further including securing a rating of the consumer investment units by a credit rating agency.

19. The method of creating a financial instrument of claim 16, wherein the step of rating the consumer investment units by a credit rating agency further includes rating the financial instruments by Standard & Poor's, Moody's Investors Service, Inc. or such other recognized credit rating agency acceptable to investors.

20. The method of creating a financial instrument of claim 16, wherein the step of issuing a guarantee for the benefit of the subscribers further includes issuing a letter of credit in support of specific performance under a repurchase agreement for the financial instrument rather than specific performance of the financial instrument.

21. The method of creating a financial instrument of claim 16, further wherein an issuance fee is not charged for the guarantee.

22. A method of applying a financial instrument comprising:
issuing consistently formatted consumer investment units by retail banking or financial institutions;
reviewing the proposed consumer investment units as to Shari'ah (Islamic) investment compliance;
issuing a guarantee for the benefit of the subscribers payable in the event of default on scheduled financial instrument repurchase;
utilizing a networked infrastructure to facilitate the issuance and guarantee of consumer investment units;
developing a secondary market for consumer investment units; and
monitoring the financial instruments as to Shari'ah (Islamic) investment compliance.

23. The method of applying a financial instrument of claim 22, further including a retail bank or financial institution issuing the consumer investment units.

24. The method of applying a financial instrument of claim 23, further including selling the consumer investment units to subscribers in lieu of the deposit of funds to a Shari'ah compliant depository or investment account.

25. The method of applying a financial instrument of claim 23, further including preserving the original purchase value of consumer investment units on behalf of the subscriber via the issuance of a repurchase guarantee.

26. The method of applying a financial instrument of claim 23, further including the retail subscriber passively investing its funds and potentially receiving earnings with reduced risk of financial loss while still abiding by Shari'ah principles.

27. The method of applying a financial instrument of claim 22, further including coordinating the issuance, subscription, guarantee and Shari'ah compliance processes pertaining to the financial instrument via a network.

28. The method of applying a financial instrument of claim 27, further including the networked operations supporting the creation of a secondary market for the consumer investment units.

29. The method of applying a financial instrument of claim 27, further including the step of assembling a Shari'ah Supervisory Board in coordination with a network increases the efficiencies and breadth of the Shari'ah compliance review process.

30. The method of applying a financial instrument of claim 22, further including securing a rating of the consumer investment units by a credit rating agency.

31. The method of applying a financial instrument of claim 30 further wherein the securing of a rating of the consumer investment units further includes contributing to the creation of a secondary market for the consumer investment units.

32. A financial instrument comprising:
a consumer-oriented investment vehicle which complies with Shari'ah investment guidelines;
the investment vehicle effectuating a passive or semi-passive investment by an individual or institution which observes Islamic law in the establishment of its investment criteria and the implementation of its investment practices; and
the investment vehicle qualifying as investment-grade, ratable securities within a capital markets environment.

33. A financial instrument comprising:
a traditional, rated, consumer-oriented investment grade security in compliance with Shari'ah investment guidelines and Islamic law.
